(19) United States
(12) Patent Application Publication
(10) Pub. No.: US 2002/0031206 A1
(43) Pub. Date: Mar. 14, 2002

(54) Voice message forwarding apparatus, method for forwarding voice message, and voice message forwarding system

(76) Inventor: Kenji Matsunsami, Kyoto (JP)

Correspondence Address: ROSENTHAL & OSHA L.L.P., 1221 MCKINNEY AVENUE, SUITE 2800, HOUSTON, TX, 77010, US

(21) Appl. No.: 09/948,982

(22) Filed: Sep. 7, 2001

(30) Foreign Application Priority Data
Sep. 8, 2000 (JP) 2000-273485

(51) Int. Cl. H04M 1/64

(52) U.S. Cl. 379/67.1

(57) ABSTRACT

A voice message forwarding apparatus connected to a telephone communication network and a computer network is disclosed. The apparatus includes a device for receiving an address of a receiving terminal and a voice message sent from a sending terminal, a device for storing the address of the receiving terminal and the voice message, a device for determining whether the receiving terminal can process a voice file, a device for producing a message addressed to the receiving terminal that can process a voice file, the message containing a voice message in a voice file, a device for producing a message addressed to the receiving terminal that cannot process a voice file, the message containing an access information necessary to access the voice message forwarding apparatus to receive the voice message, a device for sending the message to the receiving terminal through the computer network, and means for reproducing and outputting the voice message stored in the voice message forwarding apparatus in response to an access from the receiving terminal.

### BACKGROUND OF INVENTION

Recently, use of Internet has spread and exchanging e-mail message through Internet using personal computers has become commonplace. E-mail can send not only text data but also a voice message by attaching a voice file to the email. Also, along with the spread of i-mode service, exchanging e-mails has become commonplace not only between personal computers but also between wireless telephones having a digital communication function. Under this situation, users of wireless telephones today can exchange text data by e-mail through the Internet besides talking to someone in a remote place on the phone.

However, wireless telephones sold on the market today generally do not have the function to process a voice file in the same manner as a personal computer. For example, it is not possible for a wireless telephone to send a voice file to terminal devices. Nor is it possible for the wireless telephone to compose a voice file and send it to personal computers. As a result, most of the transmittals of voice messages using wireless telephones are carried out by a conventional method of making a real time telephone call, or leaving a voice message recorded while the recipient is absent.

However, under this condition, when a PC user wants to e-mail a voice message to a plurality of recipients by attaching a voice file, it is not possible to do so if a wireless telephone is included among the recipients. Also, when a wireless telephone user wants to send a voice message to a plurality of recipients, because it is not possible to send a same voice file to a plurality of recipients at one time, he or she has to make phone calls to each of the plurality of recipients.

Under the above described condition, what is needed, therefore, is a system in which both wireless telephones and personal computers can be used as transmittal terminals through the Internet to perform effective voice message exchanges with other transmittal terminals.

### SUMMARY OF THE INVENTION

In general, in one aspect, the present invention is a voice message forwarding apparatus that is connected to a telephone communication network and a computer network. The apparatus comprises means for receiving a voice message and an address of a receiving terminal sent from a sending terminal, means for storing the voice message and the address of the receiving terminal, means for determining whether the receiving terminal can process a voice file, means for producing a message addressed to a receiving terminal able to process a voice file, the message containing a voice message in a voice file, means for producing a message addressed to a receiving terminal unable to process a voice file, the message containing an access information necessary to access the voice message forwarding apparatus to receive the voice message stored therein, means for sending the message to the receiving terminal through the computer network; and means for reproducing and outputting the voice message stored in the voice message forwarding apparatus in response to an access from the receiving terminal.

In general, in one aspect, the present invention is a method for forwarding a voice message by using a voice message forwarding apparatus that is connected to a telephone communication network and a computer network. The method comprises sending a voice message and an address of a receiving terminal to the voice message forwarding apparatus from a sending terminal, storing the voice message and the address of the receiving terminal in the voice message forwarding apparatus, determining whether the receiving terminal can process a voice file, producing a message addressed to a receiving terminal able to process a voice file, the message containing the voice message in a voice file, producing a message addressed to a receiving terminal that cannot process a voice file, the message containing a notice of receiving a message and an access information necessary for the receiving terminal to access the voice message stored in the voice forwarding apparatus through a telephone communication network, and sending the message thus produced to the receiving terminal from the voice message forwarding apparatus.

In general, in one aspect, the present invention is a method for forwarding a voice message from a personal computer to a wireless telephone by using a voice message forwarding apparatus that is connected to a telephone communication network and a computer network. The method comprises composing an e-mail addressed to the wireless telephone by using the personal computer, the e-mail having a voice file, sending the e-mail from the personal computer to the voice message forwarding apparatus through the computer network, storing the voice message together with the address of the wireless telephone in the voice message forwarding apparatus, composing an e-mail addressed to the wireless telephone, the e-mail containing a notice of receiving a message and an access information necessary for the wireless telephone to access the voice message stored in the voice forwarding apparatus through a telephone communication network, and sending the e-mail thus composed to the wireless telephone from the voice forwarding apparatus.

In general, in one aspect, the present invention is a method for forwarding a voice message from a wireless telephone to a personal computer by using a voice message forwarding apparatus that is connected to a telephone communication network and a computer network. The method comprises sending a voice message and an address of the personal computer to the voice forwarding apparatus from the wireless telephone through the telephone communication network, storing the voice message and the address of the personal computer in the voice message forwarding apparatus, composing an e-mail addressed to the personal computer, the e-mail containing a voice file storing the voice message, and sending the email thus composed to the personal computer from the voice message forwarding apparatus through a computer network.

In general, in one aspect, the present invention is a system for forwarding a voice message. The system comprises a voice message forwarding apparatus connected to a telephone communication network and a computer network, a sending terminal connected to the voice message forwarding apparatus, a first receiving terminal connected to the voice message forwarding apparatus through the computer network, the first receiving terminal able to process a voice file, and a second receiving terminal connected to voice message forwarding apparatus through the telephone communication network and the computer network, the second receiving terminal unable to process a voice file. Upon receiving a voice message addressed to the first receiving terminal from the sending terminal, the voice message forwarding apparatus produces a message addressed to the first receiving terminal containing the voice message in a voice file and send the message to the first receiving terminal, and, upon receiving a voice message addressed to the second receiving terminal from the sending terminal, the voice message forwarding apparatus reproduceably stores the voice message together with the address of the second receiving terminal and produces a message addressed to the second receiving terminal that contains a notice of receiving a message and an access information necessary to access the voice message stored in the voice message forwarding apparatus and send the message to the second receiving terminal.

In general, in one aspect, the present invention is a system for forwarding a voice message. The system comprises a voice message forwarding apparatus connected to a telephone communication network and a computer network, a wireless telephone wirelessly connected to the voice message forwarding apparatus through the telephone communication network and the computer network, the wireless telephone able to receive an e-mail from the voice message forwarding apparatus, and a personal computer connected to the voice message forwarding apparatus through the computer network, the personal computer able to process a voice file. Upon receiving a voice message addressed to the personal computer from the wireless telephone through the telephone communication network, the voice message forwarding apparatus composes an e-mail addressed to the personal computer containing the voice message stored in a voice file and send the e-mail to the personal computer through the computer network. Also, upon receiving a voice message addressed the wireless telephone from the personal computer network, the voice message forwarding apparatus stores the voice message and the address of the wireless telephone and send a message that contains a notice of receiving a message and an access information necessary to access the voice message stored in the voice message forwarding apparatus to the wireless telephone.

### BRIEF DESCRIPTION OF DRAWINGS

FIG. 1 is a block diagram in accordance with one or more embodiment of a network system using the present invention.

FIG. 2 is a block diagram in accordance with one or more embodiment of a VDM (Voice de Mail) server in FIG. 1.

FIG. 3 is a block diagram in accordance with one or more embodiment of a wireless telephone in FIG. 1.

FIG. 4 is a block diagram in accordance with one or more embodiment of a personal computer in FIG. 1.

FIG. 5 is a flow chart explaining the process of the user registration and the registration of voice message recipient lists by wireless telephone users.

FIG. 6 is a flow chart explaining the steps for forwarding a voice message to a registered recipient from a wireless telephone using the voice message forwarding system of the present invention.

FIG. 7 is a flow chart explaining the steps for forwarding a voice messages to a registered recipient from a personal computer using the voice message forwarding system of the present invention.

### DETAILED DESCRIPTION

Referring now to the drawings wherein like reference characters are used for like parts throughout the several views, the present invention is explained in detail as follows.

The present invention involves a voice message forwarding apparatus, a method for forwarding voice message, and a voice message forwarding system.

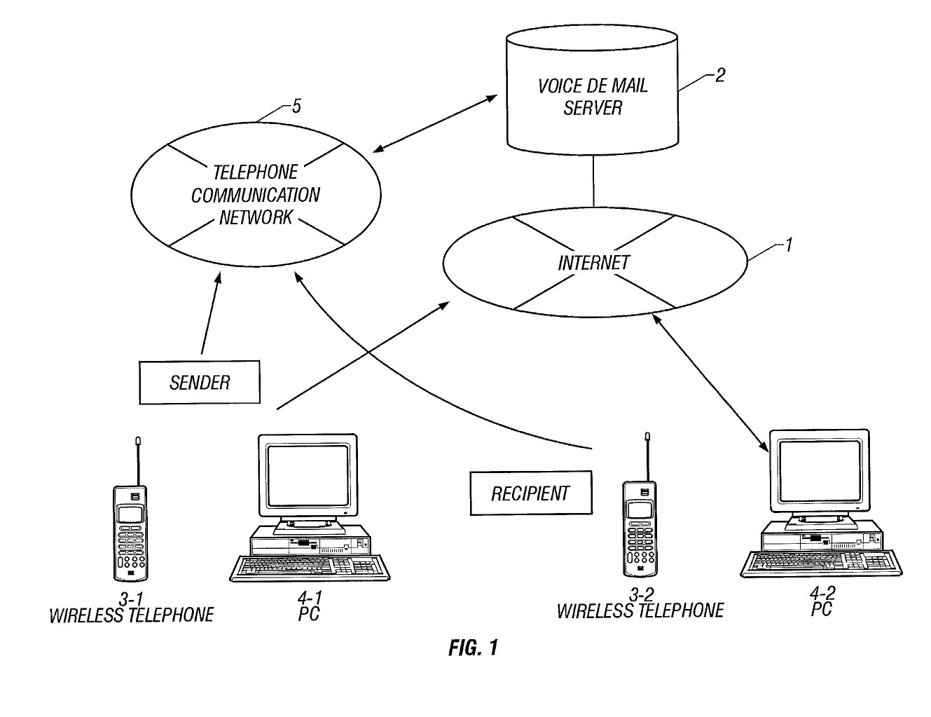

FIG. 1 shows an embodiment of the network system using the present invention. According to this embodiment, a VDM (Voice de Mail) server (2) is connected to Internet (1). At a sender side, a wireless telephone (3-1) and a PC (Personal Computer) (4-1) are connected to the Internet (1). At a recipient side, a wireless telephone (3-2) and a PC (4-2) are also connected to the Internet (1). The wireless telephones (3-1, 3-2), and the VDM server (2) are also connected to a telephone communication network (5).

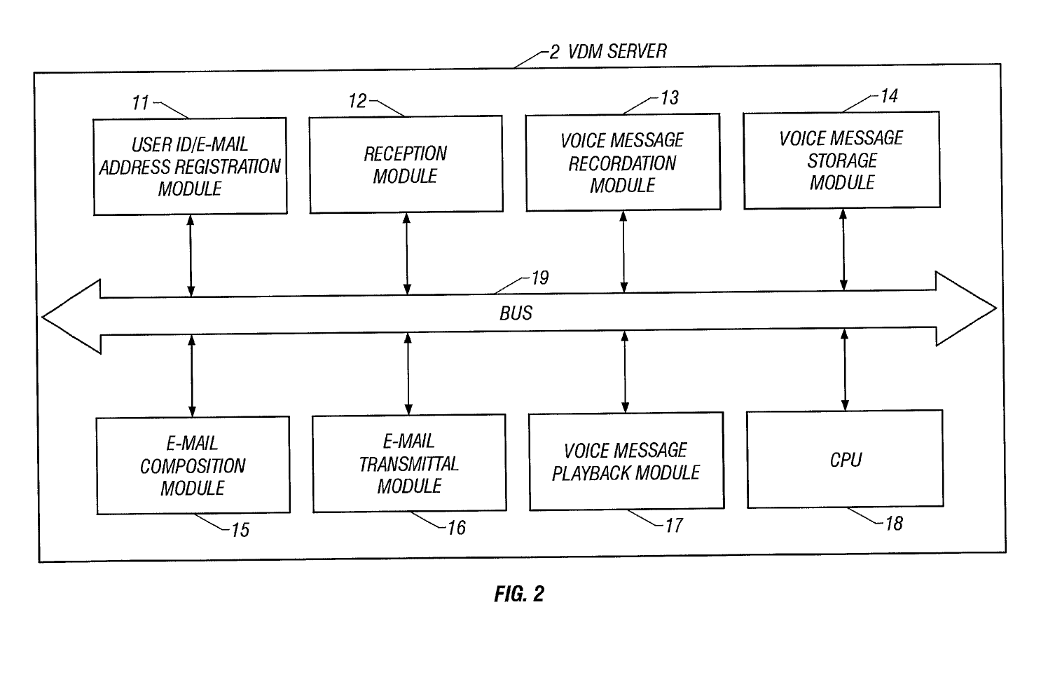

The VDM server (2) is configured, for example, as shown in FIG. 2. The VDM server (2) is provided with a user ID/e-mail address registration module (11), a reception module (12), a voice message recordation module (13), a voice message storage module (14), an e-mail composition module (15), an e-mail transmittal module (16), a voice message playback module (17), and a CPU (18). These modules are connected with each other through a bus (19).

The user ID/e-mail address registration module (11) records the user IDs and e-mail addresses of a plurality of terminal apparatuses. The reception module (12) receives e-mails or a phone calls sent from terminal apparatuses. The voice message recordation module (13) records the voice messages sent from the terminal apparatuses. The voice message storage module (14) converts the voice messages recorded at the recordation module (13) into digital data and stores them. The e-mail composition module (15) determines whether each of the terminal apparatuses is a PC or a wireless telephone. If the terminal is a PC, the e-mail composition module (15) composes an e-mail having a voice file as an attachment to the e-mail. If the terminal is a wireless telephone, the e-mail composition module (15) composes an e-mail containing information necessary to access the VDM server (2) from the wireless telephone and a notice message “a voice message has been received.” The transmittal module (16) sends the e-mail thus composed to each of the designated terminal apparatuses. The voice message playback module (17) reproduces and outputs the voice message recorded at the voice message recordation module (13) in response to an access from the user of the terminal apparatus user who has received the e-mail.

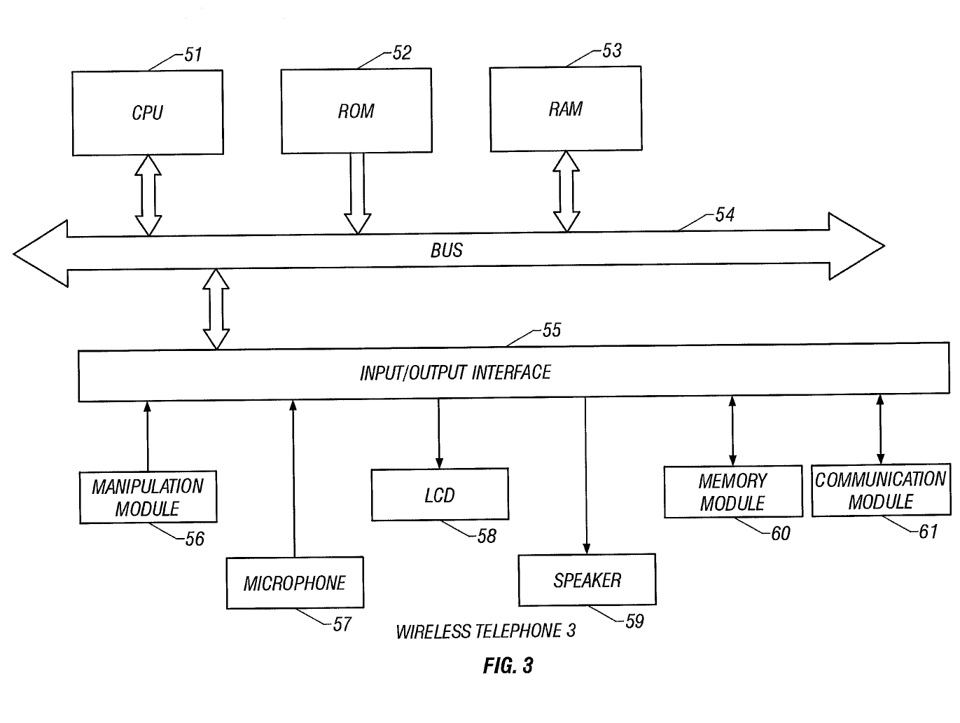

FIG. 3 shows an embodiment of the wireless telephones (3-1, 3-2) (If it is not necessary to distinguish these two telephones, they are simply called a wireless telephone (3)). These wireless telephones are used for digital communication and able to wirelessly access the telephone communication network and also send or receive digital signals through the Internet (1) as well. CPU (51) performs various tasks according to the program recorded in a ROM (52) or the program loaded from a memory module (60) to the RAM (53). The RAM (53) records the data needed for the CPU (51) to perform various tasks. The CPU (51), the ROM (52), and the RAM (53) are connected to each other through a bus (54). An input/output interface (55) is also connected to this bus (54). The input/output interface (55) is connected to an manipulation module (56), a microphone (57), a LCD (58), a speaker (59), a memory module (60) including read-only memory etc., and a communication module (61) performing transactions with the telephone communication network (5) and the Internet (1).

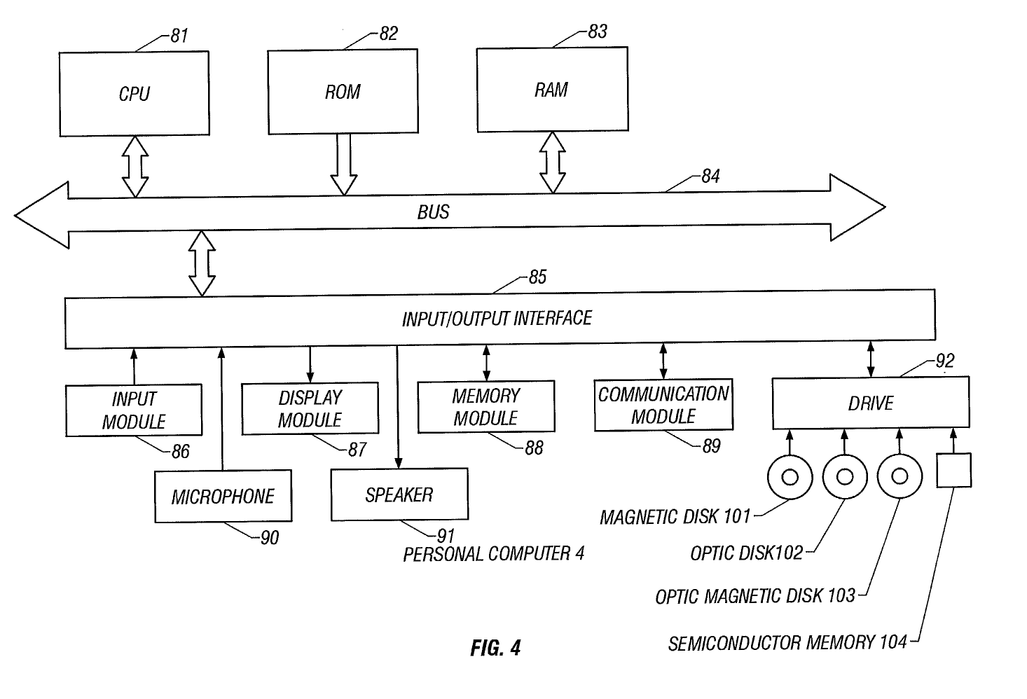

FIG. 4 shows an embodiment of PCs (4-1, 4-2) (If it is not necessary to distinguish these two PCs, they are simply called the PC (4)). In FIG. 4, the CPU (81) performs various tasks according to the program recorded in a ROM (82) or the program loaded from a memory module (88) to a RAM (83). The RAM (83) can record the data needed for a CPU (81) to perform various tasks. The CPU (81), the ROM (82), and the RAM (83) are connected to each other through a bus (84). An input/output interface (85) is also connected to the bus (84). The input/output interface (85) is connected to an input module (86) including a keyboard, mouse, etc, a display module (87) including a CRT and a LCD, etc., a memory module (88) including a hard drive, etc., a communication module (89) including modem, terminal adapter, etc. and performing transmissions with the telephone communication network (5) or the Internet (1), a microphone (90), and a speaker (91). A drive module (92) can be also connected to the input/output Interface (85). In addition, a magnetic disk (101), an optic disk (102), an optic magnetic disk (103), or a semiconductor memory (104) is installed in the drive (92) if necessary.

Further, the computer programs read out from these disks are installed in the memory module (88).

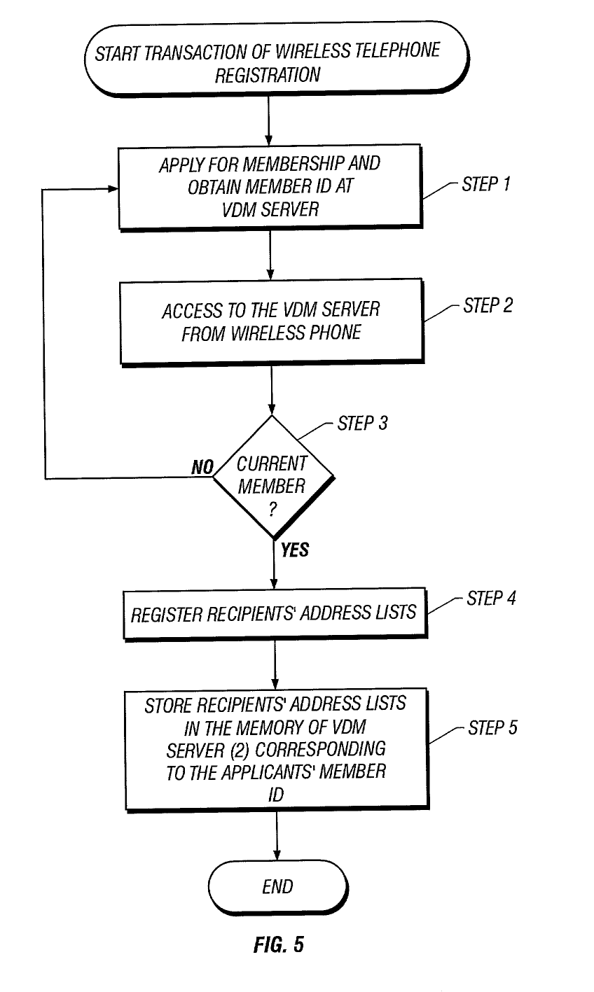

Referring to the embodiment of the network of FIG. 1 and the flow charts shown in FIGS. 5-7, an example of the service provided to the users using a voice message forwarding system of the present invention is explained as follows.

User Registration, Recipient's Address Registration

In order to receive the service rendered by the network system with the VDM server (2), the user is required to obtain a user registration. If the user already has some transmittal terminals (recipients) to which the user wants to send e-mails periodically, the user is requested to register addresses of those recipients in advance. By requiring user registrations, a service fee may be collected from the users for use of this system. And by having the addresses of the recipients of the emails that are expected to receive e-mails from the user, reliable transmission of the e-mails becomes possible under this system.

First, the user of wireless telephone (3-1) needs to apply and register for a membership of the voice message forwarding system and obtain a user ID (Step 1).

The user of the wireless telephone (3-1) then accesses the VDM server (2) through the telephone communication network by entering his/her user ID and operates the manipulation module (56). Upon receiving the command to access the VDM server (2), the wireless telephone (3-1) accesses the VDM server (2) through the telephone communication network via the communicating module (61) (Step 2).

When there is an access command from the wireless telephone (3-1) to the VDM server (2) via the reception module (12), the CPU (18) of the VDM server (2) identifies the user ID of the wireless telephone (3-1) and compares the same ID with the user IDs that are already registered in the user ID/e-mail address registration module (11) (Step 3). If the received user ID turns out to be not registered in the user ID/e-mail address registration module (11), the user of the wireless telephone (3-1) is requested to go back to Step 1 and apply for the user registration or enter his or her correct user ID. If the received user ID turns out to be registered in the user ID/e-mail address registration module (11), then subsequent steps are performed.

Next, the user of the wireless phone (3-1) enters the name(s) and the e-mail address(es) of the recipients by operating the manipulation module (56). After these data have been entered, the CPU (51) of the wireless telephone (3-1) controls the communication module (61) and sends the data to the VDM server (2) through the telephone communication network (5) (Step 4).

When the VDM server (2) receives an access command from the wireless telephone (3-1) and receives the list of the addresses of recipients via the reception module (12), the CPU (18) of the VDM server (2) sends the data to the user ID/email address registration module (12). The addresses of the recipients are stored in the user ID/e-mail address registration module (12) corresponding to the user ID of the sender (Step 5). By doing this, the e-mails sent from the wireless telephone (3-1) can be forwarded easily to the recipients whose addresses are already registered. In one or more embodiments of the present invention, the VDM server (2) may be able to send e-mails to the recipient terminals who are not registered in advance.

The user of the wireless telephone (3-2) or the user of the PC (4-2), who are referred as recipients of e-mails in the above example, can also apply for the user registration and obtain the user ID and register the addresses of recipients in the VDM server (2).

While the procedure for user registration and the recipient's address registration from the wireless telephone (3-1) has been explained, the user registration and the recipient's address registration can be conducted in an approximately same manner from the PC (4) through Internet (1).

Sending a Voice Message from a Wireless Telephone

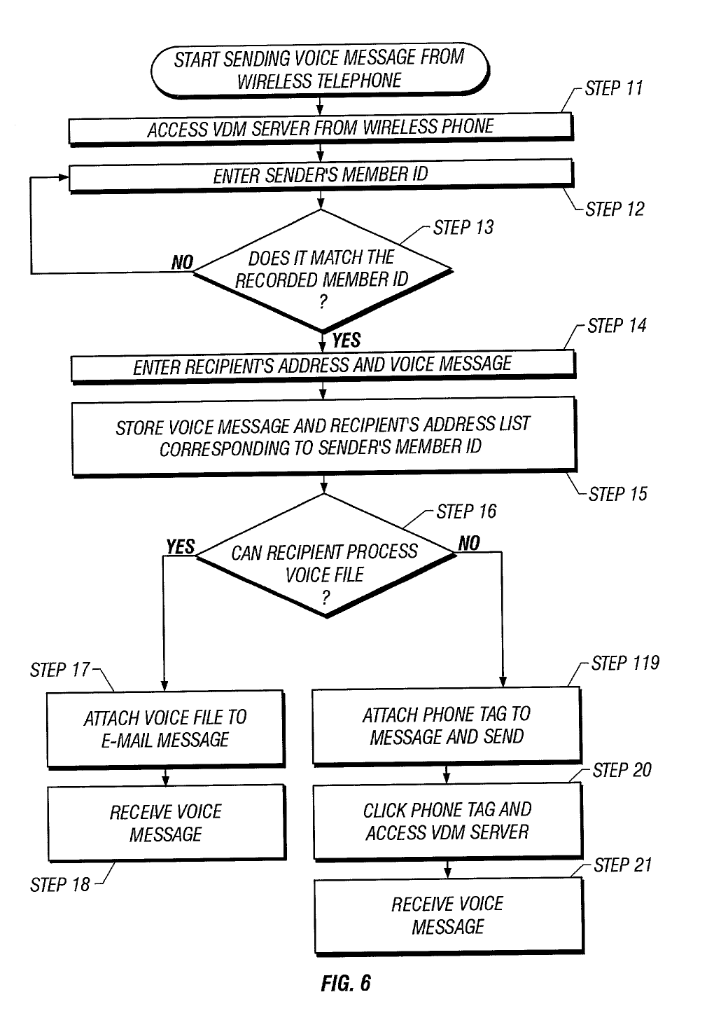

Referring to the network embodiment of FIG. 1 and a flow chart shown in FIG. 6, after completing the user registration and recipient's address registration, a procedure for sending an e-mail from a wireless phone (3-1) to another wireless telephone (3-2) or a PC (4-1) is explained.

First, the user of the wireless telephone (3-1) sends an access command to the VDM server (2) by operating the manipulation module (56). In response to this command, the CPU (51) of the wireless telephone (3-1) controls the communication module (61) and accesses the VDM server (2) through the telephone communication network (5) (Step 11).

Next, the user enters his/her user ID (Step 12). When the CPU (18) of the VDM server (2) receives the access command from the wireless telephone (3-1) via the reception module (12), the CPU (18) compares the sender's ID received from the wireless telephone (3-1) with the user IDs that are already registered in the user ID/e-mail address registration module (11) (Step 13). If the received user ID turns out to be not registered, the user of the wireless telephone is requested to go back to Step 12 and input a correct user ID or apply for a user registration. If the received user ID turns out to be registered, subsequent steps are performed.

Next, the user enters the recipient's address and inputs a voice message to be sent to the recipient(s) by using a microphone (57) (Step 14). The address or addresses of the recipient(s) and the voice message are sent via the communicating module (61) to the VDM server (2) through the telephone communication network (5).

Next, when the CPU (18) of the VDM server (2) receives the message sent from the wireless telephone (3-1) via the reception module (12), the message is supplied to the user ID/e-mail address registration module (11) and is recorded corresponding to its recipients' address and the sender's user ID (Step 15).

The e-mail composition module (15) of the VDM server (2) determines whether the recipient's terminal apparatus can process a voice file attached to the e-mail (Step 16). If the recipient's terminal apparatus is the PC (4) that can process a voice file, the e-mail composition module (15) composes an e-mail having a voice file attached to the e-mail (Step 17). If the recipient's terminal apparatus is a wireless telephone (3) which is unable to process a voice file, the e-mail composition module (15) of the VDM server (2) composes an e-mail having a phone tag which enables the recipient to access the VDM server (2) through the telephone communication network (5) (Step 19). For example, if the user of the wireless telephone (3-1) composes an e-mail to be sent to the wireless telephone (3-2), this phone tag is attached to the e-mail.

The e-mail composed by the e-mail composition module (15) is sent from the VDM server (2) to the wireless telephone (3-2) through the Internet (1). The CPU (51) of the wireless telephone (3-2) receives the e-mail from the VDM server (2) via the communication module (61) thereof. At this time, the CPU (51) of the wireless telephone (3-2) displays a notice of receiving a message on the LCD (58).

This display includes the above described phone tag.

The user of the wireless telephone (3-2) who has been notified a reception of a new message can access to the new message by simply clicking the phone tag to operate the manipulation module (56). When the user clicks the phone tag displayed on the LCD (58), the CPU (51) controls the communication module (61) based on the information (i.e., a telephone number in the VDM server (2)) that is linked to the phone tag, so that the wireless telephone (3-2) can access the VDM server (2) through the telephone communication network (5) (Step 20).

Upon receiving an access command from the recipient, the CPU (18) of the VDM server (2) reproduces the voice message recorded in the voice message storage module (14) and outputs the same to the recipient (in this case, the recipient is the wireless telephone (3-2)) through the telephone communication network (5) (Step 21).

When this message is received by the wireless telephone (3-2) via the communication module (61) through the telephone communication network (5), the received voice message is output from the speaker (59) of the wireless telephone (3-2). If the wireless telephone (3-2) has a memory module (60), the voice message can be recorded therein.

When the voice message is recorded in the memory module (60), that message can be read out and output from the speaker (59). In this manner, the user can repeatedly listen the voice message at any time.

On the other hand, when the recipient terminal of the e-mail is the PC (4-1) that is able to process a voice file, the voice message is sent to the PC (4-1) as a voice file attached to the e-mail through the Internet (1).

Sending a Voice Message From a PC

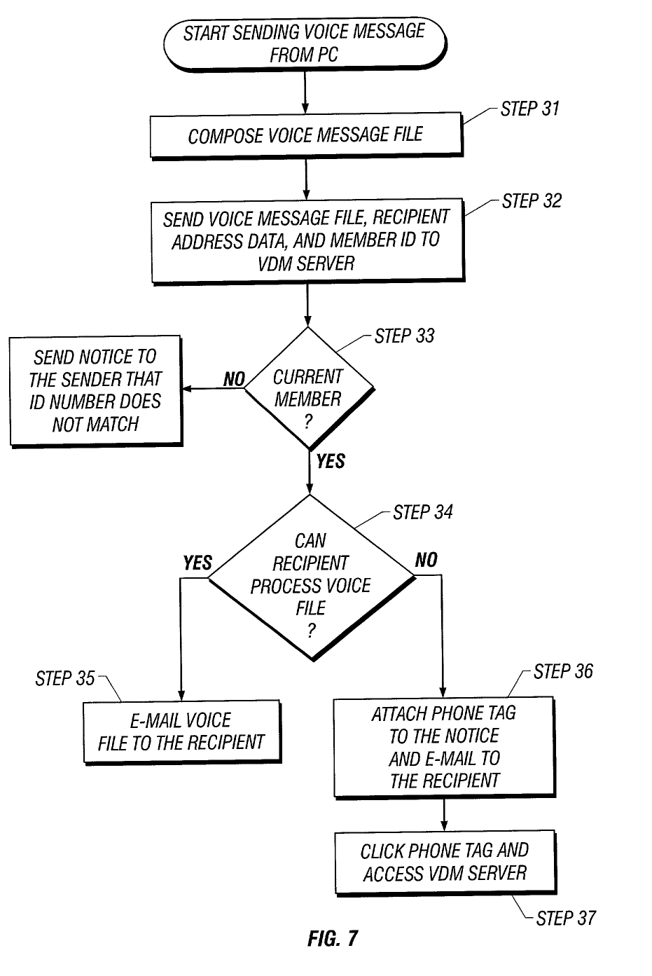

Next, sending a voice message from the PC (4-2) to the wireless telephone (3-1) is explained referring to an embodiment of FIG. 1 and the flow chart of FIG. 7.

First, the user of the PC (4-2) composes a voice file by recording his or her voice message by using a microphone (90) and converting the voice message into digital data (Step 31). Then, the user sends the e-mail having an attachment of a voice file to the VDM server (2) together with the e-mail addresses of the recipient(s) and his/her user ID through the Internet (1) (Step 32).

When the VDM server (2) receives a message sent from the PC (4-2) via the communication module (89), the VDM server (2) compares the received user ID with the user IDs which are already registered in the user ID/e-mail address registration module (11) (Step 33). If the received user ID turns out to be not registered in the VDM server (2), the sender of the user ID is notified that the received user ID is not registered and the sender is requested to enter a new ID or apply for a user registration. If the ID received from the PC (4-2) turns out to be registered in the VDM server (2), subsequent steps are performed.

Next, the e-mail composition module (15) of the VDM server (2) determines whether the recipient terminal apparatus can process a voice file (Step 35). If the recipient terminal is a PC that can process a voice file, the e-mail having an attachment of voice file is sent to the recipient terminal (Step 36). If the recipient terminal is a wireless telephone (3-1) that cannot process a voice file, the CPU (18) of the VDM server (2) sends the e-mail to the wireless telephone (3-1) informing the recipient that a new message has been received together with a phone tag that can be used by the recipient to access the VDM server (2) to receive the voice message through the telephone communication network (Step 37).

The user of the wireless telephone (3-1) who received the e-mail sent from the VDM server (2) through the Internet (1) can access to the voice message by clicking the phone tag by operating the manipulation module (56). When the phone tag is clicked by the user, the CPU (51) controls the communication module (61) based on the information (at least including the telephone number in the VDM server (2)) linked to the phone tag and access the VDM server (2) and make the wireless telephone (3-1) access the VDM server (2) through the telephone communication network (5).

When the CPU (18) of the VDM server (2) receives an access command from the wireless telephone (3-1), it reproduces the voice message recorded in the storage module (14) and outputs the same to the user of the wireless telephone (3-1) through the telephone communication network (5) (step 37).

When the user of the wireless telephone (3-1) receives the voice message from the communication module (61) through the telephone communication network (5), the received voice message can be output from the speaker (59) of the wireless telephone (3-1). If the wireless telephone (3-1) has a voice message memory apparatus, the voice message can be recorded in the memory module (60) and users can repeatedly listen the voice message at any time.

In the above description, although the telephones have been referred as wireless telephones, one skilled in the art can appreciate that wired telephones can also be used as a transmittal terminal in the network system of the present invention as long as they have an e-mail correspondence function via Internet.

Also, in the same above description, although personal computers have been referred as a terminal that can process voice file, one skilled in the art can appreciate that other computers, including a workstation can be also used as long as an e-mail correspondence and a voice file processing function exist.

Also, in the above embodiments, although the service of the e-mail forwarding system of the present invention has been explained as the service requiring a user registration and the addresses of the recipients, one skilled in the art can appreciate that the service under the system is not restricted to that form.

Also, providing or using the service of this system without requiring such user registration or recipients address registration is possible.

According to one or more embodiments of the present invention, by having a voice recognition device with the wireless telephone, the sender of the voice message can input all of the data including the user ID and addresses of the recipients by his/her voice and send the data to the recipients. By doing so, the users not familiar with the manipulation of the wireless telephone can easily send his/her voice message to the recipients.

According to the voice message forwarding apparatus of the present invention, wireless telephone users can compose a voice file at the voice message forwarding apparatuses and send them to the recipients' terminals even if the devices do not have an ability to compose or send the voice message files. Therefore, it is possible for the wireless telephone users to forward a voice file to the personal computers through Internet.

According to the voice message forwarding apparatus of the present invention, because the voice messages of the wireless telephone are stored in the voice message forwarding apparatus in a reproduceable manner, the wireless telephone which cannot process a voice file can also receive the voice messages by accessing the voice messages recorded in the voice message forwarding apparatus.

According to the voice message forwarding system of the present invention, the users who send voice messages from wireless personal communication apparatuses can send voice messages to a plurality of recipients at one time regardless of whether the recipient terminal is a personal computers that can process a voice file or a wireless telephone which cannot process a voice file. Therefore, an effective transmittal of voice messages to a plurality of recipients including PC terminal and telephone terminal becomes possible.

Although the description above contains many specific examples, these should not be construed as limiting the scope of the invention but as merely providing illustrations of some embodiments of this invention. Thus, the scope of the invention should be determined by the appended claims and their legal equivalents, rather than by the examples given.

What is claimed is:

1. A voice message forwarding apparatus connected to a telephone communication network and a computer network, comprising:
means for receiving a voice message and an address of a receiving terminal sent from a sending terminal;
means for storing the voice message and the address of the receiving terminal and;
means for determining whether the receiving terminal can process a voice file;
means for producing a message addressed to a receiving terminal able to process a voice file, the message containing a voice message in a voice file;
means for producing a message addressed to a receiving terminal unable to process a voice file, the message containing the access information necessary to access the voice message forwarding apparatus to receive the voice message stored therein;
means for sending the message to the receiving terminal through the computer network; and
means for reproducing and outputting the voice message stored in the voice message forwarding apparatus in response to an access from the receiving terminal.

2. The apparatus according to claim 1, further comprising means for registering a sending terminal and a receiving terminal.

3. A method for forwarding a voice message by using a voice message forwarding apparatus that is connected to a telephone communication network and a computer network, comprising:
sending a voice message and an address of a receiving terminal to the voice message forwarding apparatus from a sending terminal;
storing the voice message and the address of the receiving terminal in the voice message forwarding apparatus;
determining whether the receiving terminal can process a voice file;
producing a message addressed to a receiving terminal able to process a voice file, the message containing the voice message in a voice file;
producing a message addressed to a receiving terminal that is unable to process a voice file, the message containing a notice of receiving a message and an access information necessary for the receiving terminal to access the voice message stored in the voice forwarding apparatus through the telephone communication network; and
sending the message thus produced to the receiving terminal from the voice message forwarding apparatus.

4. The method according to claim 3, further comprising registering the sending terminal and the receiving terminal before sending a message from the sending terminal.

5. A method for forwarding a voice message from a personal computer to a wireless telephone using a voice message forwarding apparatus that is connected to a telephone communication network and a computer network, comprising;
composing an e-mail addressed to the wireless telephone using the personal computer, the e-mail having a voice file;
sending the e-mail from the personal computer to the voice message forwarding apparatus through the computer network;
storing the voice message together with the address of the wireless telephone in the voice message forwarding apparatus;
composing an e-mail addressed to the wireless telephone, the e-mail containing a notice of receiving a message and an access information necessary for the wireless telephone to access the voice message stored in the voice forwarding apparatus through a telephone communication network; and
sending the e-mail thus composed to the wireless telephone from the voice forwarding apparatus.

6. A method for forwarding a voice message from a wireless telephone to a personal computer by using a voice message forwarding apparatus that is connected to a telephone communication network and a computer network, comprising:
sending a voice message and an address of the personal computer to the voice forwarding apparatus from the wireless telephone through the telephone communication network;
storing the voice message and the address of the personal computer in the voice message forwarding apparatus;
composing an e-mail addressed to the personal computer, the e-mail containing a voice file storing the voice message; and
sending the e-mail thus composed to the personal computer from the voice message forwarding apparatus through a computer network.

7. A system for forwarding a voice message, comprising:
a voice message forwarding apparatus connected to a telephone communication network and a computer network;
a sending terminal connected to the voice message forwarding apparatus;
a first receiving terminal connected to the voice message forwarding apparatus through the computer network, the first receiving terminal able to process a voice file; and
a second receiving terminal connected to voice message forwarding apparatus through the telephone communication network and the computer network, the second receiving terminal unable to process a voice file;
wherein, upon receiving a voice message addressed to the first receiving terminal from the sending terminal, the voice message forwarding apparatus produces a message addressed to the first receiving terminal containing the voice message in a voice file and send the message to the first receiving terminal, and, upon receiving a voice message addressed to the second receiving terminal from the sending terminal, the voice message forwarding apparatus reproduceably stores the voice message together with the address of the second receiving terminal and produces a message addressed to the second receiving terminal that contains a notice of receiving a message and an access information necessary to access the voice message stored in the voice message forwarding apparatus and send the message to the second receiving terminal.

8. The system according to claim 7, wherein the sending terminal is provided with a voice recognition device so that a user of the sending terminal can verbally send all of data including address of a receiving terminal.

9. A system for forwarding a voice message, comprising:
a voice message forwarding apparatus connected to a telephone communication network and a computer network,
a wireless telephone wirelessly connected to the voice message forwarding apparatus through the telephone communication network and the computer network, the wireless telephone able to receive an e-mail from the voice message forwarding apparatus; and
a personal computer connected to the voice message forwarding apparatus through the computer network, the personal computer able to process a voice file;
wherein, upon receiving a voice message addressed to the personal computer from the wireless telephone through the telephone communication network, the voice message forwarding apparatus composes an e-mail addressed to the personal computer containing the voice message stored in a voice file and send the e-mail to the personal computer through the computer network, and, upon receiving a voice message addressed the wireless telephone from the personal computer through the computer network, the voice message forwarding apparatus stores the voice message and the address of the wireless telephone and send a message that contains a notice of receiving a message and an access information necessary to access the voice message stored in the voice message forwarding apparatus to the wireless telephone.
